(19) United States
(12) Patent Application Publication
(10) Pub. No.: US 2015/0132519 A1
(43) Pub. Date: May 14, 2015

(54) Rapidly Deployed Nano Material Structures

(71) Applicant: John Sullivan, Marriottsville, MD (US)

(72) Inventor: John Sullivan, Marriottsville, MD (US)

(21) Appl. No.: 14/076,126

(22) Filed: Nov. 8, 2013

(51) Int. Cl. C08L 47/00; B29C 33/38

(52) U.S. Cl. CPC C08L 47/00; B29C 33/38
USPC 428/36.92; 425/470; 428/521; 442/290; 524/554

(57) ABSTRACT

Structural elements comprised of functionalized material in a rapidly setting resin. The structural elements are rapidly deployable and arranged as structures that provide ballistic and impact resistance. The structures are fabricated using specific molds that shape a specific rapid cure resin-filler mixture.

### CROSS-REFERENCE TO RELATED APPLICATION

This application claims the priority of U.S. provisional application 61/724,942 filed on Nov. 10, 2012 which is incorporated by reference herein in its entirety.

### STATEMENT REGARDING FEDERALLY SPONSORED RESEARCH OR DEVELOPMENT

Not Applicable

### BACKGROUND OF THE INVENTION

This invention describes structural elements comprised of functionalized material in a rapidly setting resin.

### DESCRIPTION OF RELATED ART

Rapidly deployable structures for military and civilian use typically are in the form of tents and structures that provide minimal protection from enemy or natural forces. These temporary or permanent structures are typically time demanding to assemble and do not provide much protection for personnel and equipment. More protective structures are constructed from difficult to transport materials such as concrete and steel, and these are labor intensive and expensive to build.

### SUMMARY OF THE INVENTION

This invention is rapidly deployable structures that provide ballistic and impact resistance. The structures are fabricated using specific molds that shape a specific rapid cure resin-filler mixture. The fillers are typically sand, silica, ceramic, silica fume, silica flower, nano powders, metal fibers, plastic fibers, Kevlar fabrics and the like, that are plasma functionalized. Plasma functionalization or activation involves subjecting the filler to a high power atmospheric pressure plasma to remove weak boundary layers and improve the adhesion properties of the surface and opening the pores. When blended with the proper resin, the resultant composite structure is extremely tough. For this invention, a preferred resin is pDCPD (poly-Dicyclopentadiene). pDCPD has exceptional toughness, is about 25% lighter than typical epoxies and has good ballistic penetration resistance. Any resin of interest also should have a low viscosity, catalyze quickly and be nano-sized to fit into places where longer chain polymers cannot.

In a preferred embodiment, the resin and functionalized filler are blended together and a catalyst added and the mixture is pumped into a bladder that acts as a mold for the structure. The filler could be made from material found at the site, such as silica sand, or from a wide variety of materials that can be selected based upon their mechanical properties and ability to be functionalized by the plasma. The catalyst and amount of catalyst used is selected carefully such that is provides a rapid cure, but without causing an overly exothermic reaction. In addition, the bladders or molds used must be made of a material compatible with the catalyst.

In one embodiment, the filled nano-resin composite is used to fill bladders that act as molds for structural components arranged as ballistic or impact resistant shelters. In a preferred embodiment, the bladder molds are made of ripstop nylon coated urethane or rigid pre-cast molds. In a preferred embodiment, the bladders are further supported and separated by wall dividers that the bladders are hot welded to maintain their shape without ballooning and structural integrity while the resin is curing. In another embodiment, these structural components are further arranged with high performance concrete and optionally woven polypropylene to provide for even greater ballistic protection. In a further configuration, thermal insulation is interspersed with the structural components. In another embodiment, the filled nano-resin composite is used as protective surface material for a balloon antenna or air ship in a ball in ball configuration. In a preferred embodiment, the ball inside a ball is configured with two bladders, where the inner bladder is filled with air and the outer bladder contains the resin composite with resin, concrete or a foam material. An electric control valve and bleeder valve connect the interior air filled chamber with the exterior.

### BRIEF DESCRIPTION OF THE DRAWINGS

While some embodiments of this invention describe a unique mixture of resin and a functionalized filler, the drawings are used to demonstrate the embodiments of this invention in which the resin-filler composite is used for structural applications.

Drawing 1 shows tubular wall channels.

Drawing 2 shows dividers and joints in tubular channels.

Drawing 3 shows a half dome constructed of tubular channels.

Drawing 4 shows a sphere constructed of tubular channels.

Drawing 5 shows double wall dividers in tubular channels.

Drawing 6 shows a stack of divided tubular channels.

Drawing 7 is another configuration of stacked divided tubular channels.

Drawing 8 is a frame of a structure constructed of tubular channels.

Drawing 9 shows walls covering a tubular channel frame.

Drawing 10 is the exterior view of the shelter of Drawing 9.

Drawing 11 shows a configuration of offset channels of a structural member.

Drawing 12 is a cross-section view of Drawing 11.

Drawing 13 shows the stacking of the structural members of Drawing 11.

Drawing 14 is a ball mold for a spherical structure.

Drawing 15 is the detail of the valve and wall configuration of the ball mold.

Drawing 16 shows the structure of Drawing 13 as configured for ballistic protection.

Drawing 17 is a zig zag sheet of composite material

Drawing 18 is stacked zig zag sheets

### DESCRIPTION OF THE PREFERRED EMBODIMENTS

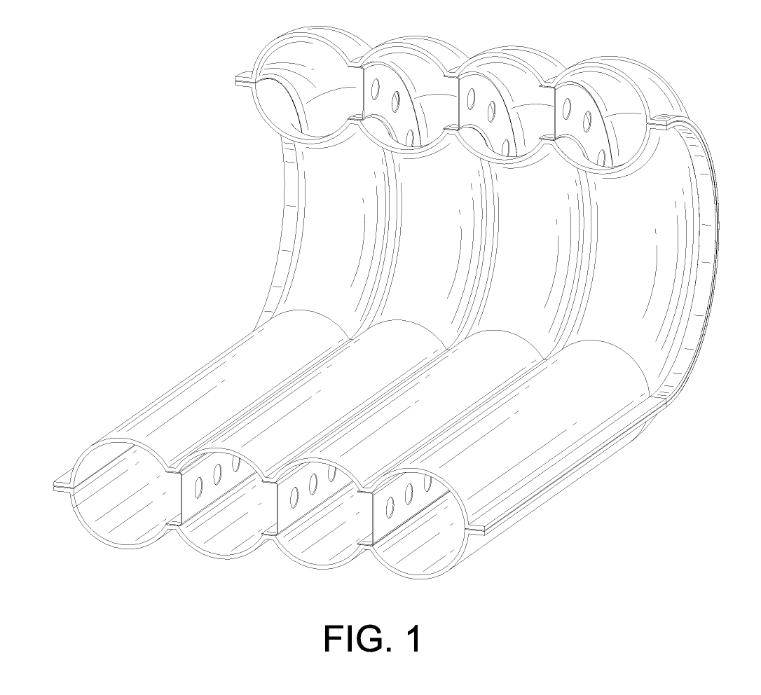

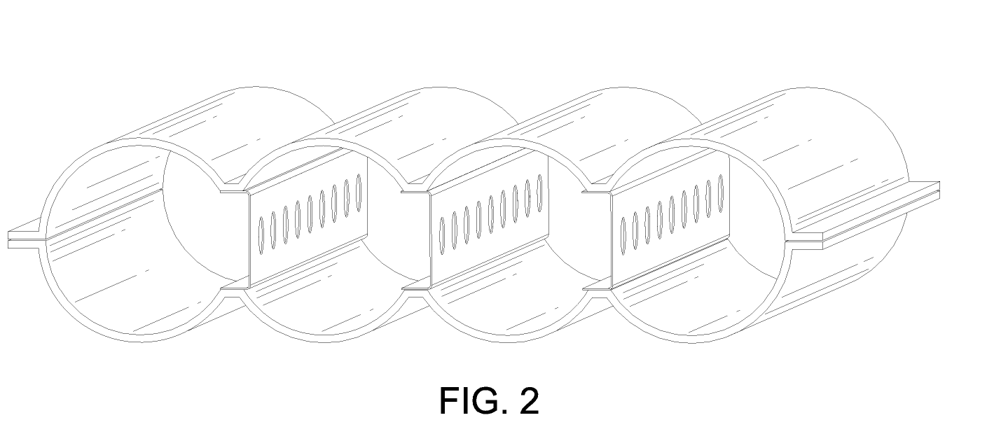

In FIG. 1, the bladder used as a mold for the composite is stiffened and the segments separated by stiff polymer dividers. The bladder material, which may be comprised of ripstop nylon coated urethane, are welded to the dividers. The dividers are not meant to keep the segments contents separated but just to provide structural stiffness and thus they are perforated to prevent the bag from ballooning. FIG. 2 shows a close up view of the divider and the bladder wall.

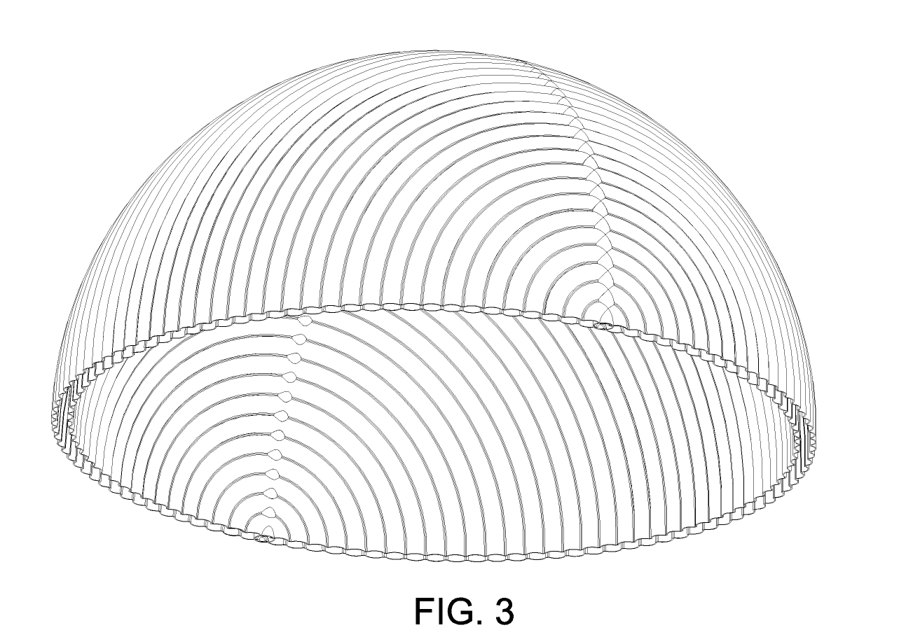

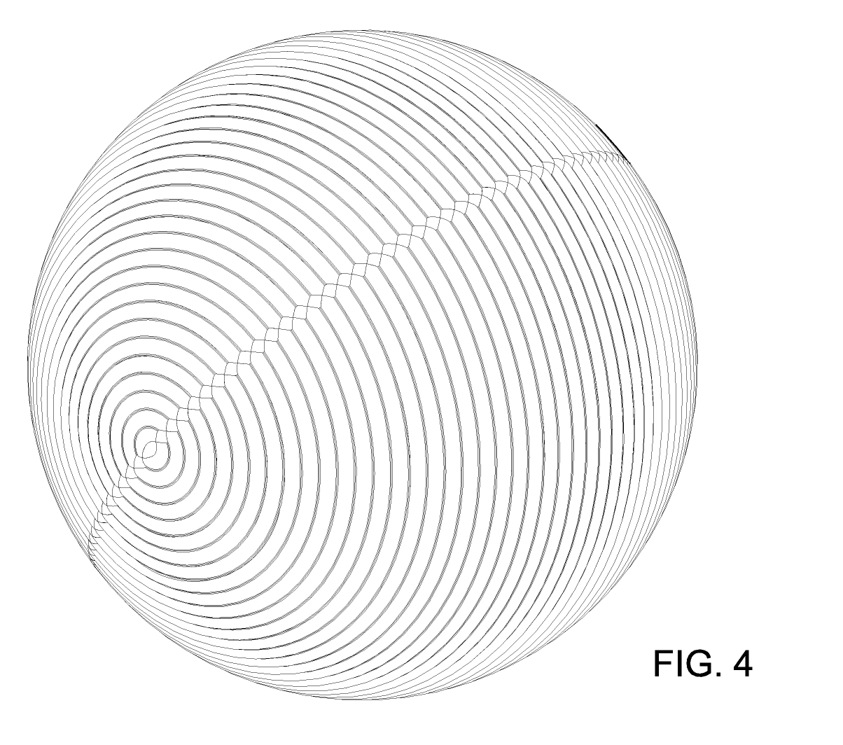

FIG. 3 shows a configuration in which the molds are used to make cylindrical segments that are curved and arranged to form a half dome structure. This structure can be a rapidly deployed structure to protect men or materials. FIG. 4 shows the further use of the cylindrical segments as arranged in a full spherical configuration.

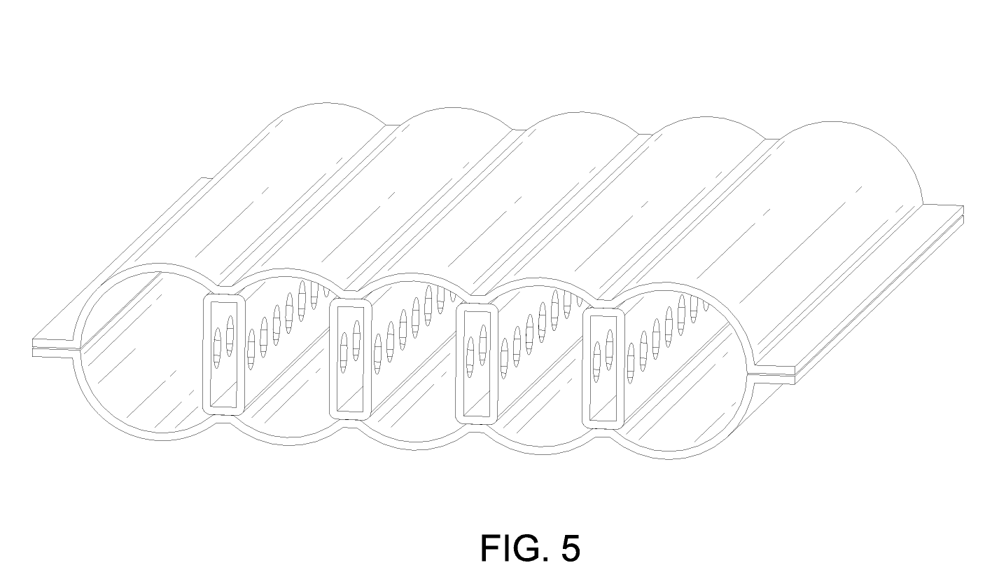

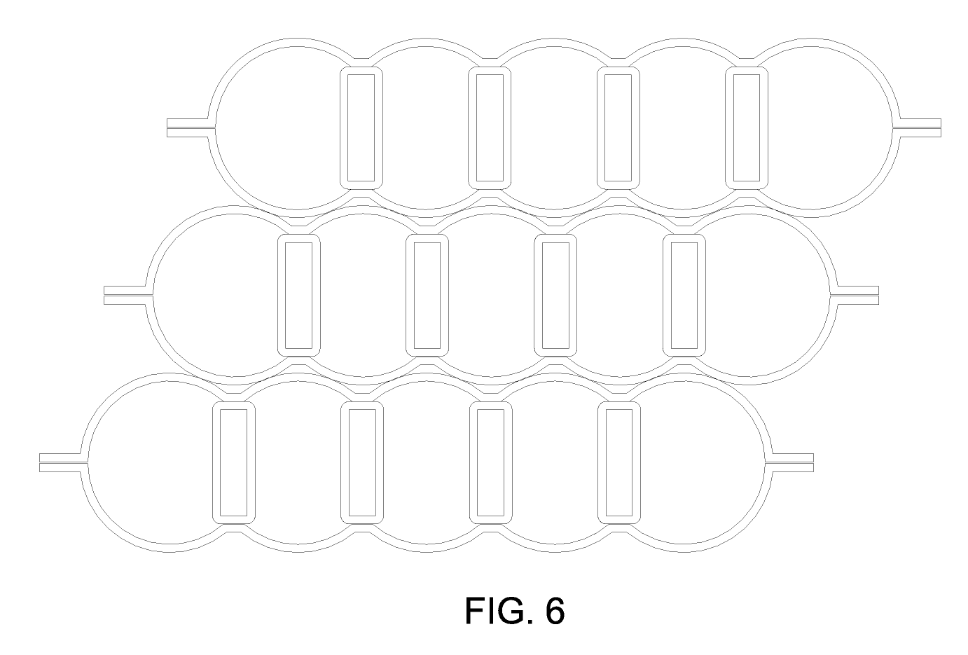

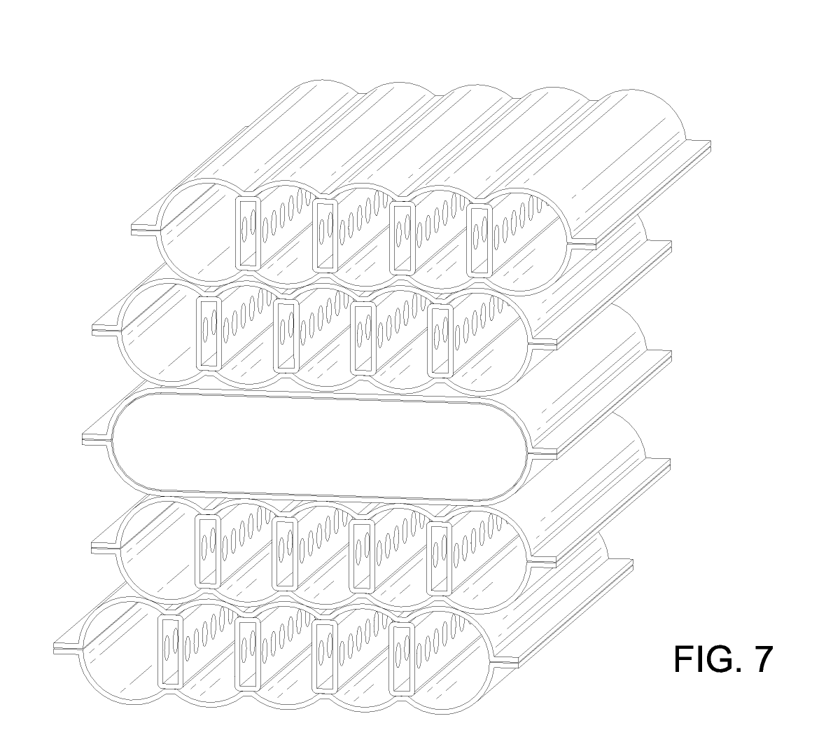

For greater stiffness, double wall dividers can be used and shown in FIG. 5. The cylindrical segments are typically constructed as a series of segments and these series could be stacked as shown in FIG. 6 for additional protection. FIG. 7 shows how the stacked series could also be interspersed with thermal insulation segments and that concrete or resin could be used to fill some segments instead of a composite if desired.

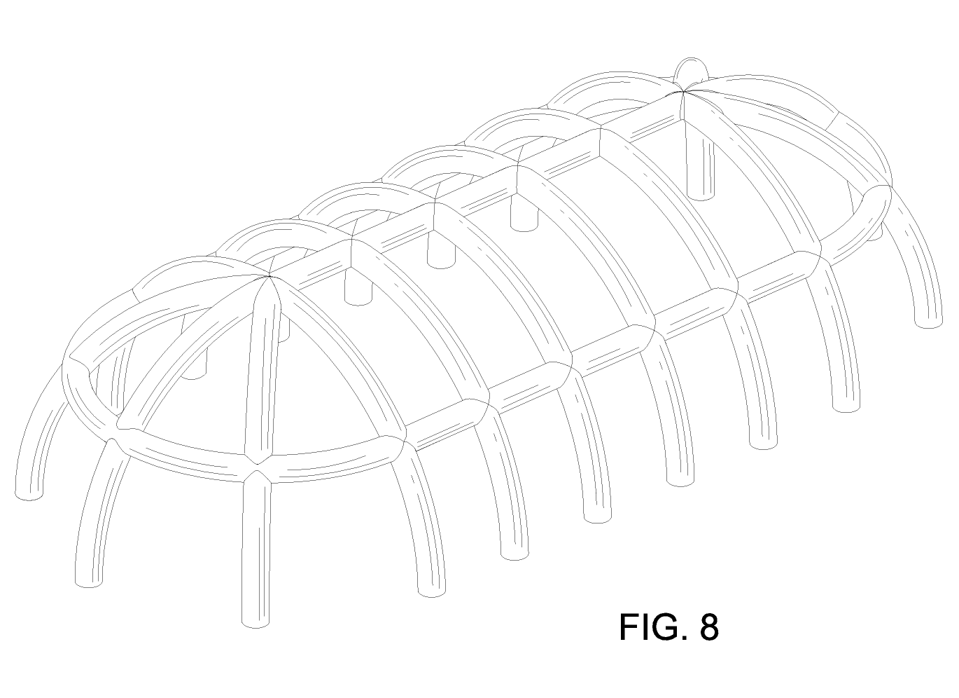

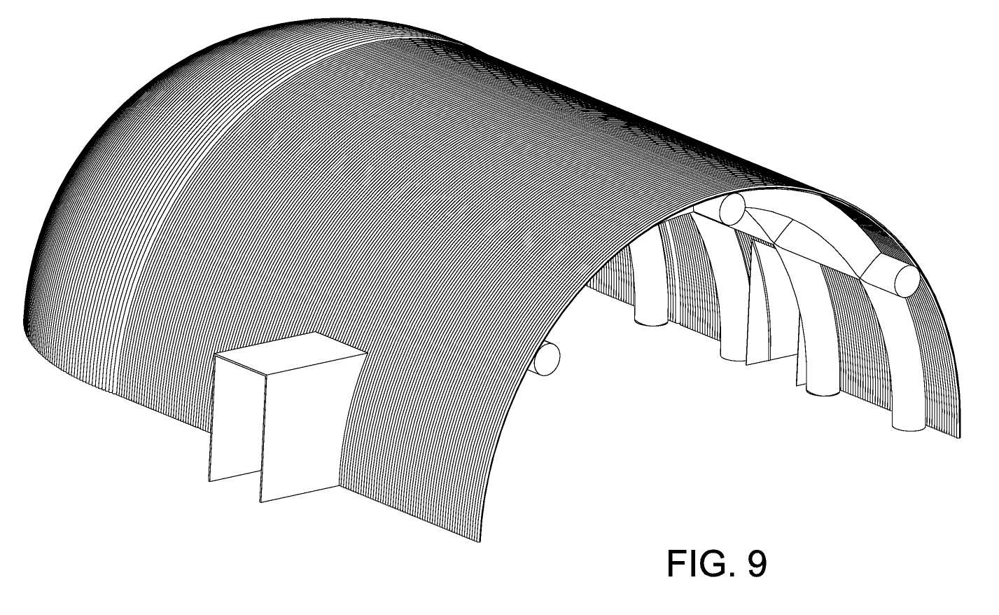

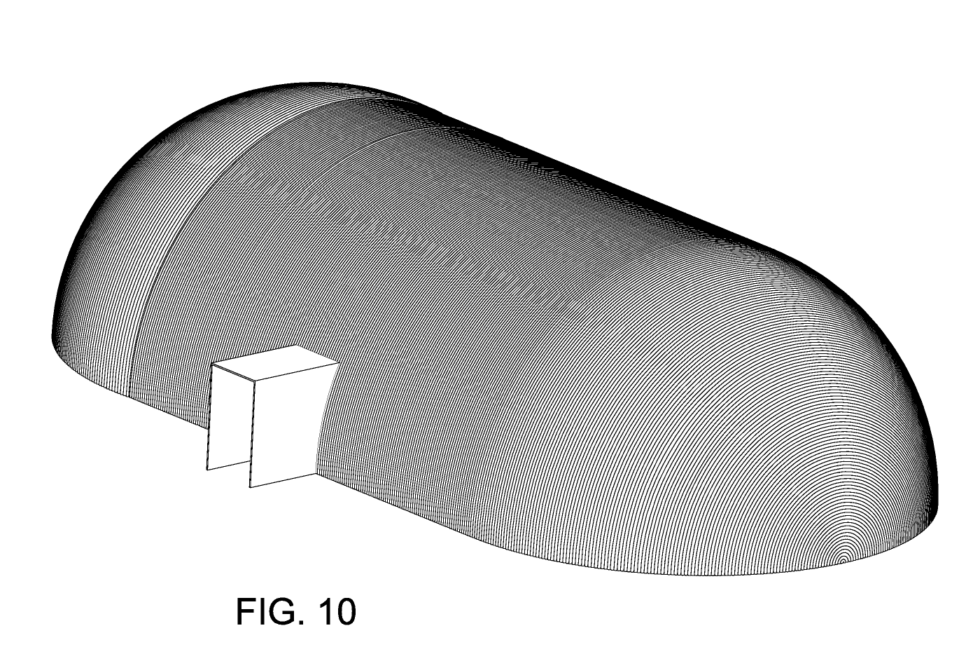

The cylindrical segments could also be used as structural beams. FIG. 8 shows these beams arranged as a frame for a rapidly deployable structure. In a cutaway view, FIG. 9 shows the beams being used to support exterior walls to form an enclosed structure. These walls may be made from resin or other materials. A view of the enclosed structure is provided in FIG. 10.

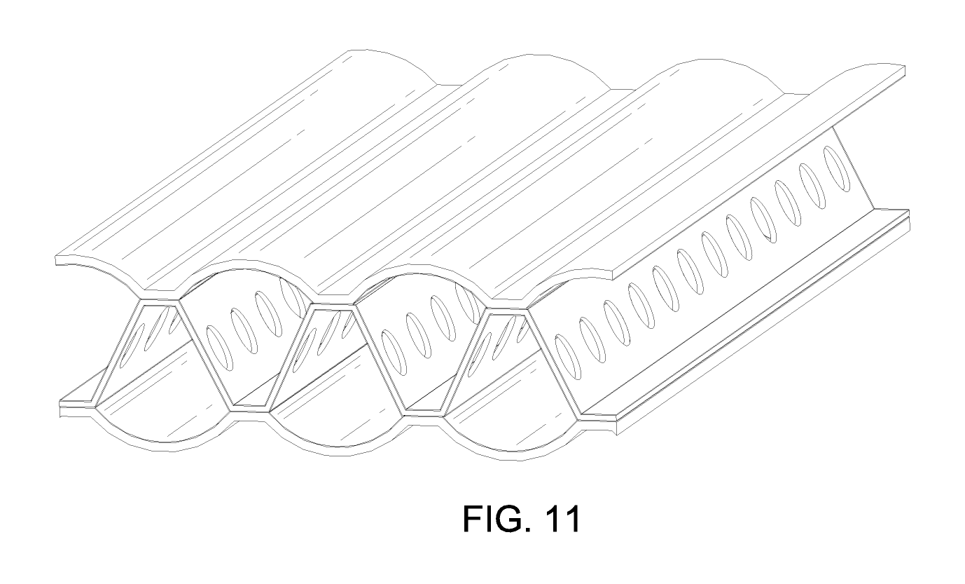

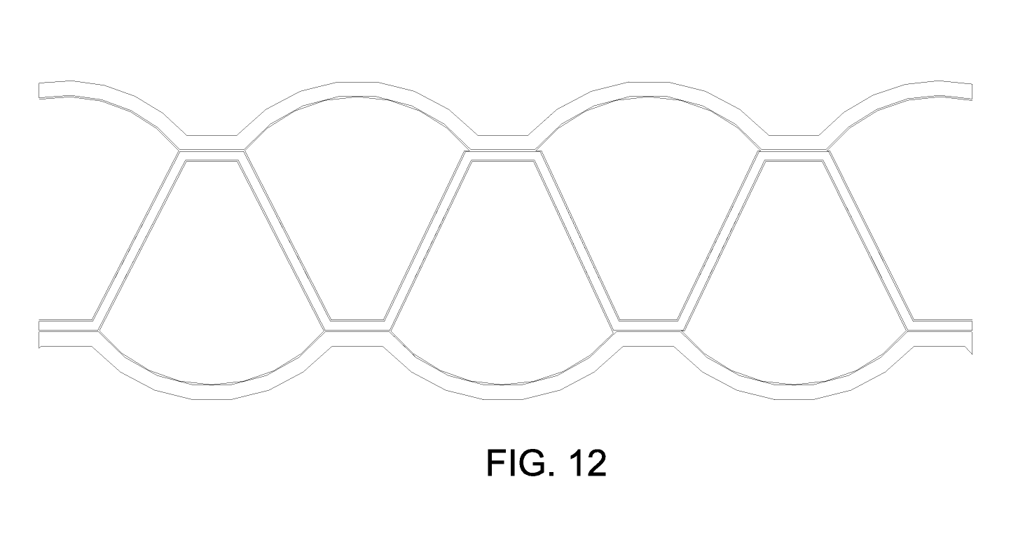

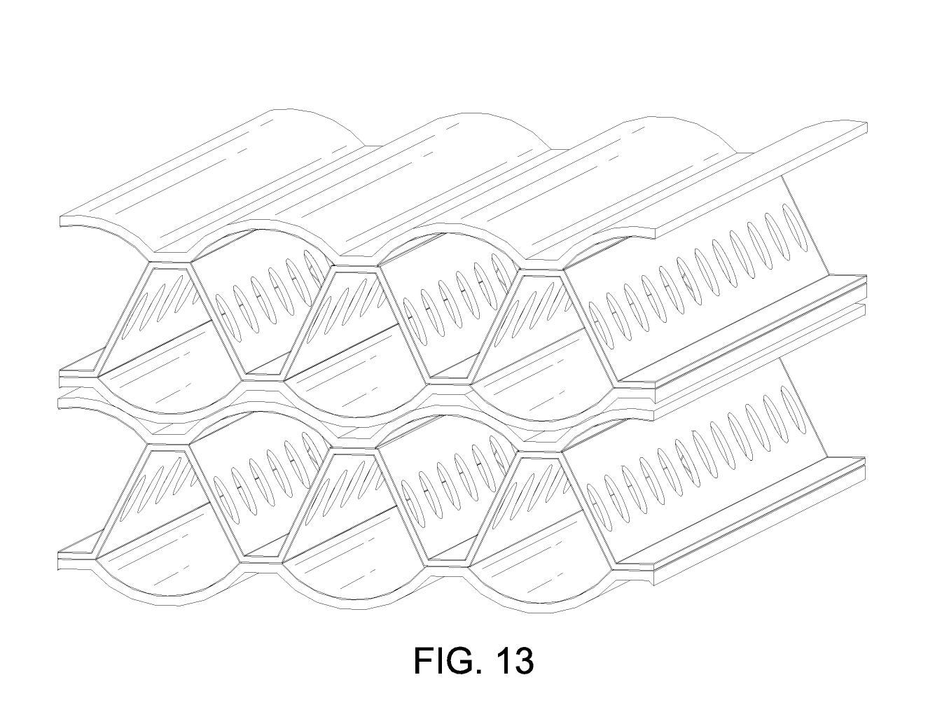

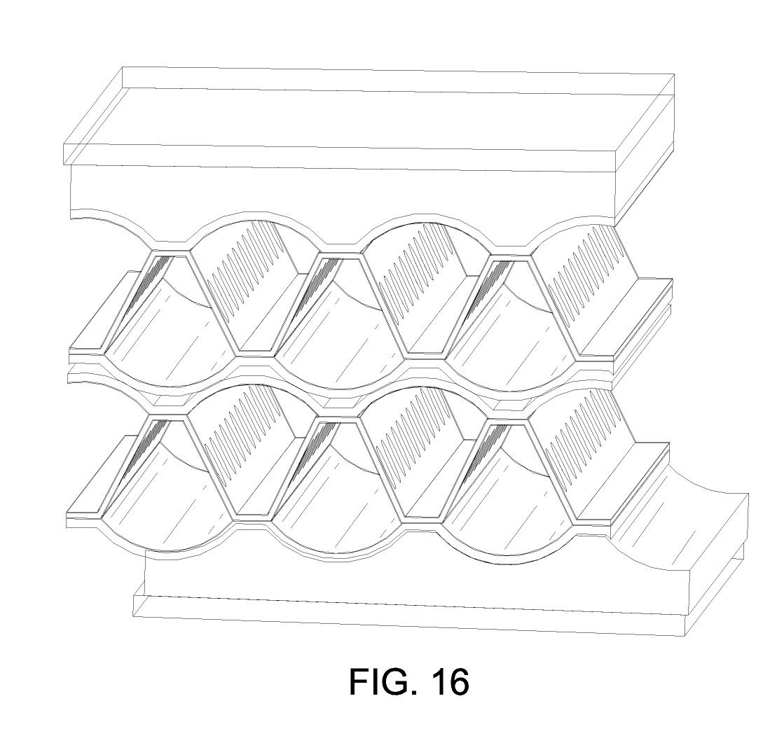

Various configurations of segments could be used and one with good structural stiffness is shown in FIG. 11 and FIG. 12. The arches and dividers are set up in a kind of truss system to ensure that the structure can handle high applied loads. The use of these type of series of segments is shown in FIG. 13 where the outer layers can be filled with concrete or resin. In this stacked configuration, the offset of the segments provide good ballistic protection as the weakest path through the dividers is backed up by the composite. In another configuration, these segmented series are stacked and further surrounded by high performance concrete and woven polypropylene material for further ballistic protection as shown in FIG. 16.

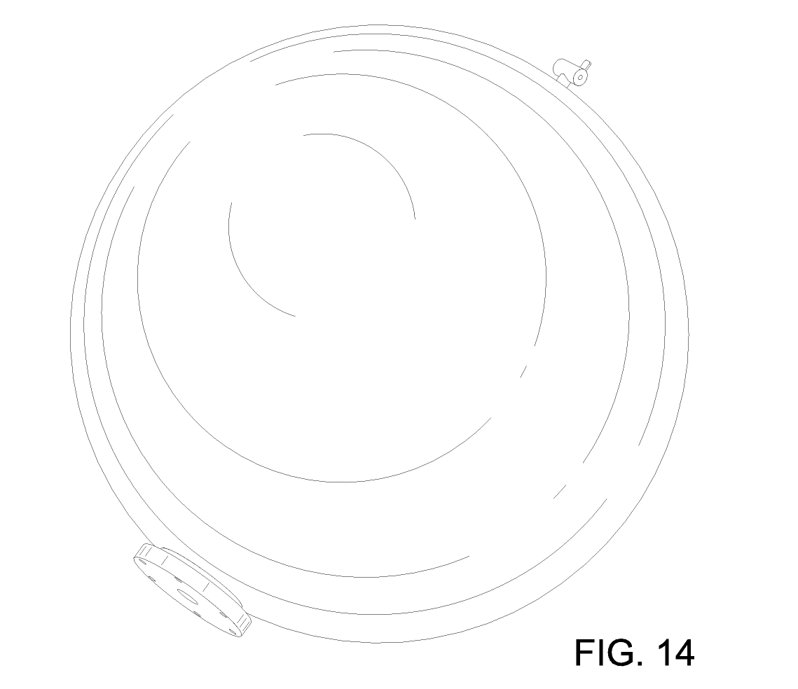

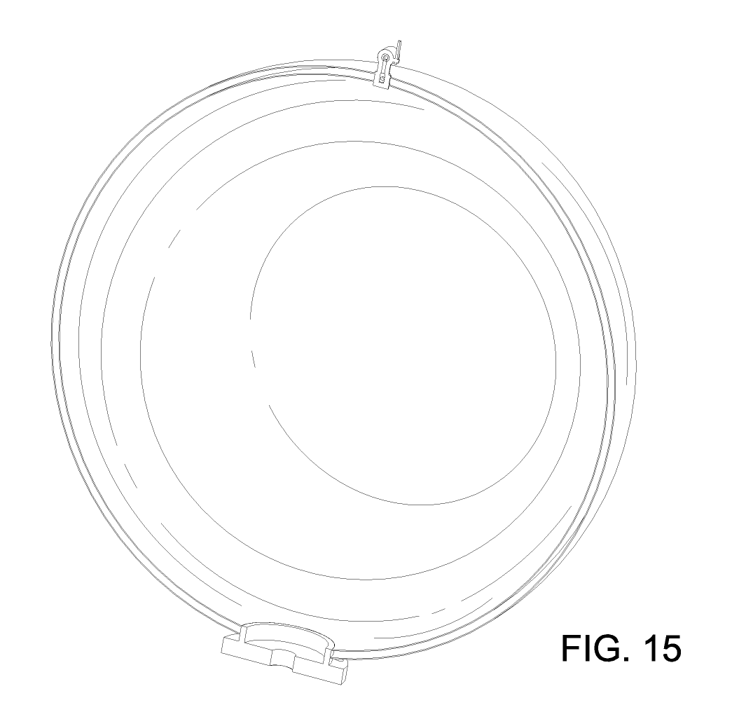

The exterior of a ball mold is shown in FIG. 14, where a bleeder valve and an air fill valve are also shown. In the detail of FIG. 15, the bleeder/filler valve configuration is visible as are the two bags or bladders. This is a ball in ball type of mold where the interior is filled with air and covered with a resin composite or concrete layer. This exterior layer is both structural and provides protection, including ballistic resistance to the interior. Such a structure could be used for many purposes including airships or ball antennae.

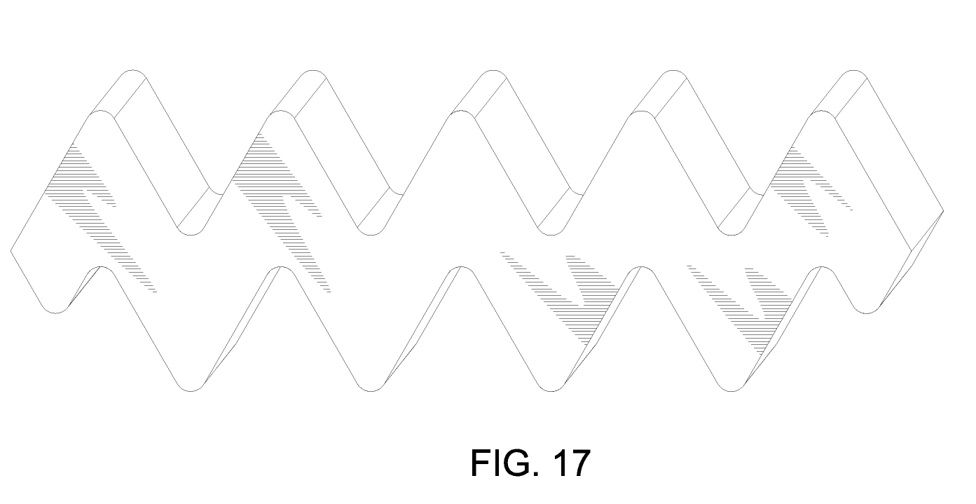

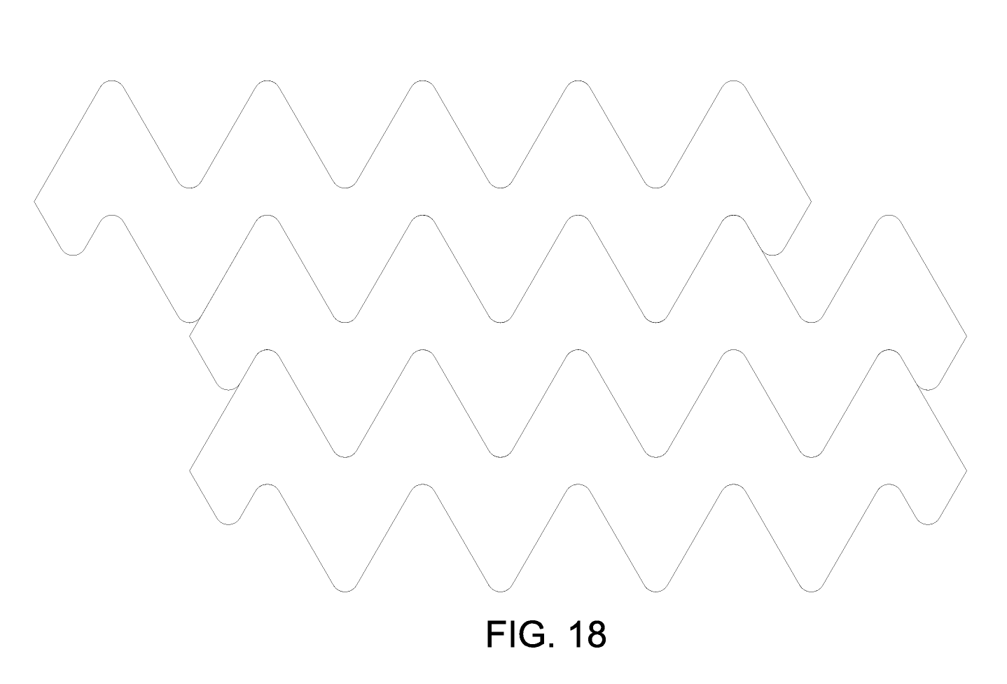

FIG. 17 shows another configuration of how the molds can be used to shape the composite material. The zig zag pattern increases ballistic resistance by providing a longer path that a projectile would have to travel through. This pattern could be made in sheets for easy construction and could be stacked as shown in FIG. 18.

1. A structure that is fabricated from a resin-filler mixture wherein said filler is functionalized via a plasma process.

2. The structure of claim 1 in which said mixture is molded into shapes that comprise the building blocks of said structure.

3. The mixture of claim 1 in which said resin is comprised primarily of poly-Dicyclopentadiene (pDCPD).

4. The mixture of claim 1 in which said resin and filler and blended together with a catalyst that is used to provide a rapid cure without resulting in an overly exothermic reaction.

5. The mixture of claim 1 in which said filler is selected from a group of materials including silica sand that are able to be functionalized by the plasma process.

6. The structure of claim 1 that is used to provide ballistic or impact resistant shelter.

7. The structure of claim 1 that is built up of separate components comprised of a resin-filler mixture such that each component was blended and poured into a mold of their desired shape.

8. The mold of claim 7 that is comprised of rip-stop nylon coated urethane or rigid pre-cast material.

9. The mold of claim 8 wherein the mold cavity is divided and supported by walls of mold material that have been hold welded to the cavity walls.

10. A structural component made using the mold of claim 7 wherein an interior second bladder mold is located inside the exterior first bladder mold wherein the inner bladder mold is filled with air and the outer bladder mold is filled with the resin-filler mixture and a control and bleeder valve are used to connect the interior air chamber with the exterior.

11. The structural component of claim 10 wherein said outer mold is further filled with additional resin, concrete or foam material.

12. The structure of claim 10 wherein said structure is used as a protective surface material for a balloon antenna or air ship.

13. A structural component comprised of a resin-filler mixture wherein said filler has been plasma functionalized and said component is fabricated by pouring the mixture into a mold and curing it.

14. A structure fabricated from structural components of claim 12 wherein said structure is further arranged with high performance concrete.

15. The structure of claim 13 that is further arranged with woven polypropylene.

16. The structure of claim 13 that is further arranged with thermal insulation.
